(19) United States
(12) Patent Application Publication
(10) Pub. No.: US 2026/0301034 A1
(43) Pub. Date: Oct. 1, 2026

(54) TRANSPORT CHARGE CALCULATING METHOD AND SYSTEM

(71) Applicant: YEN-HO LU, Taichung (TW)

(72) Inventor: YEN-HO LU, Taichung (TW)

(21) Appl. No.: 19/576,420

(22) Filed: Mar. 24, 2026

(30) Foreign Application Priority Data
Mar. 28, 2025 (TW) 114112106
Jul. 17, 2025 (TW) 114127118

(51) Int. Cl. G06Q 30/0283; G06Q 50/40

(52) U.S. Cl. CPC G06Q 30/0284; G06Q 50/40

(57) ABSTRACT

A transport charge calculating method includes the following steps of: a server detecting a first moving parameter of a first electronic device and a second moving parameter of a second electronic device of a transportation, and calculating the first moving parameter and the second moving parameter to generate a route segment when the first moving parameter is corresponding to the second moving parameter, wherein the first moving parameter and the second moving parameter include at least one of a moving route, a moving time, a moving speed and a moving acceleration, the second electronic device stores a transportation data, and the route segment includes a boarding position and a get-off position; the server determining a transport type according to the route segment and the transportation data; and the server generating a transport charge according to the boarding position, the get-off position, the route segment and the transport type.

### BACKGROUND OF THE INVENTION

### 1. Field of the Invention

The present invention relates to a transportation system, especially to a transport charge calculating method and system.

### 2. Description of the Prior Art

With the gradual improvement of transportation infrastructure and the rise of the sharing economy, public transportation has gradually become the preferred mode of transportation for commuting and travel. Compared to driving cars and motorcycles, public transportation not only offers greater convenience but also reduces carbon emissions, thus implementing environmental protection policies.

However, taking public transportation inevitably requires purchasing tickets in advance online or at ticket counters and machines. If the passenger is unsure of the way to their destination or route during a long journey, the inability to purchase tickets in advance can cause significant inconvenience. Furthermore, even if the passenger knows their intended destination, purchasing tickets remains a considerable hassle. Firstly, if the passengers choose to purchase tickets online, they may need to spend time familiarizing themselves with different systems and payment methods depending on the mode of transportation. Secondly, if the passengers choose to purchase tickets in person, they may face long queues due to crowds, or encounter problems such as complicated ticket machines that only accept specific payment methods (e.g., cash or credit cards only). Furthermore, people sometimes need to buy the wrong type of ticket due to being in a hurry and have to pay extra. All of these situations increase inconvenience for passengers in a rush, thereby reducing the management efficiency and convenience of transportation.

Therefore, it is necessary to develop a new transportation management mechanism to solve the problems of previous technologies.

### SUMMARY OF THE INVENTION

As a green and life-enhancing innovation, the present invention proposes a revolutionized transport charge method and system that embraces the benefits of inexpensiveness of public rides (i.e. bus) with an intelligent transport charge mechanism that makes payment effort and wait-time for ticket to a minimally negligible condition. The invention aims to greatly reduce the needs of rides for a greener environment.

One embodiment of the present invention provides a transport charge calculating method including the following steps of: a server detecting a first moving parameter of a first electronic device of an user and a second moving parameter of a second electronic device of a transportation, and comparing and calculating the first moving parameter and the second moving parameter to generate a route segment when the first moving parameter is corresponding to the second moving parameter, wherein the first moving parameter and the second moving parameter include at least one of a moving route, a moving time, a moving speed and a moving acceleration, and the second electronic device stores a transportation data corresponding to the transportation, the route segment includes a starting position and a terminal position, the starting position is a boarding position and the terminal position is a get-off position; the server determining a transport type of the transportation according to the route segment and the transportation data; and the server generating a transport charge according to the boarding position, the get-off position, the route segment and the transport type.

Wherein, the transportation data includes one of a transportation plate number, a transportation age, a device data and an identification code. The step of the server generating the transport charge according to the boarding position, the get-off position, the route segment and the transport type further comprises the following step of: the server generating the transport charge according to the boarding position, the get-off position, the route segment, the transport type and the transportation data.

Wherein, the transport charge calculating method further includes the following step of: when the server detecting a first position of the first electronic device located in a distance range value of a stopping position of a driving route of the transportation, the server comparing the first moving parameter and the second moving parameter.

Wherein, the transport charge calculating method further includes the following steps of: the server calculating a stopping time of a first position of the first electronic device located in a stopping position of a driving route of the transportation; and the server comparing the first moving parameter and the second moving parameter when the stopping time is greater than a preset time.

Wherein, the transport charge calculating method further includes the following step of: the server stopping comparing the first moving parameter and the second moving parameter during a preset rest period.

Wherein, the transportation includes a plurality of carriages, and the carriages are corresponding to a carriage level respectively. The transport charge calculating method further includes the following steps of: the server calculates the first moving parameter and the second moving parameter to generate at least one distance between the first electronic device and the second electronic device; the server determines the first electronic device located in a first carriage of the carriages according to the at least one distance. And, the step of the server generating the transport charge according to the boarding position, the get-off position, the route segment and the transport type further comprises the following step of: the server generating the transport charge according to the boarding position, the get-off position, the route segment, the transport type and a first carriage level corresponding to the first carriage.

Wherein, the transport charge calculating method further includes the following steps of: the server calculating a first stopping time length of the first electronic device located in the first carriage; the server generating a total riding time length according to the route segment. And, the step of the server generating the transport charge according to the boarding position, the get-off position, the route segment, the transport type and a first carriage level corresponding to the first carriage further comprising the following step of: when the proportion of the first stopping time length and the total riding time length is greater than a proportion threshold value, the server generating the transport charge according to the boarding position, the get-off position, the route segment, the transport type and the first carriage level.

Wherein, the step of the server determining the first electronic device located in the first carriage of the carriages according to the at least one distance further comprises the following steps of: the server determines the first electronic device located in the first carriage and a second carriage of the carriages according to the at least one distance; the server calculates a first stopping time length of the first electronic device located in the first carriage and a second stopping time length of the first electronic device located in the second carriage; and, the step of the server generating the transport charge according to the boarding position, the get-off position, the route segment, the transport type and a first carriage level corresponding to the first carriage further comprising the following steps of: the server generates a total riding time length according to the route segment; the server calculates the ratio of the first stopping time length to the total riding time length to generate a first time ratio, and calculates the ratio of the second stopping time length to the total riding time length to generate a second time ratio; and the server generates the transport charge according to the boarding position, the get-off position, the route segment, the transport type, the first time ratio, the first carriage level, the second time ratio and a second carriage level corresponding to the second carriage.

Wherein, the step of the server determining the first electronic device located in the first carriage of the carriages according to the at least one distance further comprises the following steps of: the server determines the first electronic device located in the first carriage of the carriages according to a first distance; the server determines the first electronic device located in a carriage position of the first carriage according to a second distance, wherein the carriage position comprises a standing area and a seat area; and, the step of the server generating the transport charge according to the boarding position, the get-off position, the route segment, the transport type and a first carriage level corresponding to the first carriage further comprising the following step of: the server generates the transport charge according to the boarding position, the get-off position, the route segment, the transport type, the first carriage level and the carriage position.

One embodiment of the present invention provides a transport charge calculating system including a first electronic device, a transportation and a server. The transportation includes a second electronic device. The second electronic device stores a transportation data corresponding to the transportation. The server is communicated with the first electronic device and the second electronic device, and the server further includes a position detecting unit, an analyzing unit and a charge calculating unit. The position detecting unit is configured to detect a first moving parameter of the first electronic device and a second moving parameter of the second electronic device, wherein the first moving parameter and the second moving parameter include at least one of a moving route, a moving time, a moving speed and a moving acceleration. The analyzing unit is configured to compare and calculate the first moving parameter and the second moving parameter. The analyzing unit generates a route segment according to the first moving parameter and the second moving parameter when the first moving parameter is corresponding to the second moving parameter, wherein the route segment includes a starting position and a terminal position. The starting position is a boarding position and the terminal position is a get-off position. The charge calculating unit is configured to determine a transport type of the transportation according to the route segment and the transportation data, and generate a transport charge according to the boarding position, the get-off position, the route segment and the transport type.

Wherein, the transportation data includes one of a transportation plate number, a transportation age, a device data and an identification code, and the charge calculating unit generates the transport charge according to the boarding position, the get-off position, the route segment, the transport type and the transportation data.

Wherein, when the position detecting unit determines a first position of the first electronic device located in a distance range value of a stopping position of a driving route of the transportation, the analyzing unit compares the first moving parameter and the second moving parameter.

Wherein, the server further includes a counting unit. The counting unit is connected to the analyzing unit and stores a preset time. The counting unit is configured to calculate a stopping time of a first position of the first electronic device located in a stopping position of a driving route of the transportation, and the analyzing unit compares the first moving parameter and the second moving parameter when the stopping time is greater than a preset time.

Wherein, the analyzing unit stops comparing the first moving parameter and the second moving parameter during a preset rest period.

Wherein, the transportation includes a plurality of carriages, and the carriages are corresponding to a carriage level respectively. The analyzing unit calculates the first moving parameter and the second moving parameter to generate at least one distance between the first electronic device and the second electronic device, and determines the first electronic located in a first carriage of the carriages according to the at least one distance. The charge calculating unit generates the transport charge according to the boarding position, the get-off position, the route segment, the transport type and a first carriage level corresponding to the first carriage.

Wherein, the counting unit calculates a first stopping time length of the first electronic device located in the first carriage and generates a total riding time length according to the route segment. When the proportion of the first stopping time length and the total riding time length is greater than a proportion threshold value, the charge calculating unit generates the transport charge according to the boarding position, the get-off position, the route segment, the transport type and the first carriage level.

In summary, the transport charge calculating method and system of the present invention can determine whether the user is taking on transportations and automatically calculate the transport charge according to the route segment, to solve various travel problems caused by the need to buy tickets in advance when taking public transportation, thereby improving the convenience of taking public transportation.

Furthermore, the transport charge calculating method and system of the present invention also can determine whether the user intends to take the transportation according to the stopping time, and can stop comparing the first moving parameter and the second moving parameter during a preset rest period, to identify the appropriate time to start the relevant units and avoid unnecessary idling, thereby reducing energy consumption and improving system efficiency.

Moreover, the transport charge calculating method and system of the present invention also can adjust the transport charge according to the transportation data, the comfort level, carriage level, different carriages and carriage positions during the riding route, thereby improving the fairness of ticket prices and passenger satisfaction.

In addition, the transport charge calculating method and system of the present invention also can estimate the arrival time of the transportation, thereby increasing the accuracy.

### BRIEF DESCRIPTION OF THE APPENDED DRAWINGS

FIG. 1 is a flow chart diagram illustrating a transport charge calculating method in an embodiment of the present invention.

FIG. 2 is a flow chart diagram illustrating the transport charge calculating method in an embodiment of the present invention.

FIG. 3 is a flow chart diagram illustrating the transport charge calculating method in an embodiment of the present invention.

FIG. 4 is a flow chart diagram illustrating the transport charge calculating method in an embodiment of the present invention.

FIG. 5 is a flow chart diagram illustrating the transport charge calculating method in an embodiment of the present invention.

FIG. 6 is a functional block diagram illustrating a transport charge calculating system in an embodiment of the present invention.

FIG. 7 is a functional block diagram illustrating the transport charge calculating system in an embodiment of the present invention.

FIG. 8 is a flow chart diagram illustrating the transport charge calculating method in an embodiment of the present invention.

FIG. 9 is a flow chart diagram illustrating the transport charge calculating method in an embodiment of the present invention.

FIG. 10 is a flow chart diagram illustrating the transport charge calculating method in an embodiment of the present invention.

FIG. 11 is a flow chart diagram illustrating the transport charge calculating method in an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

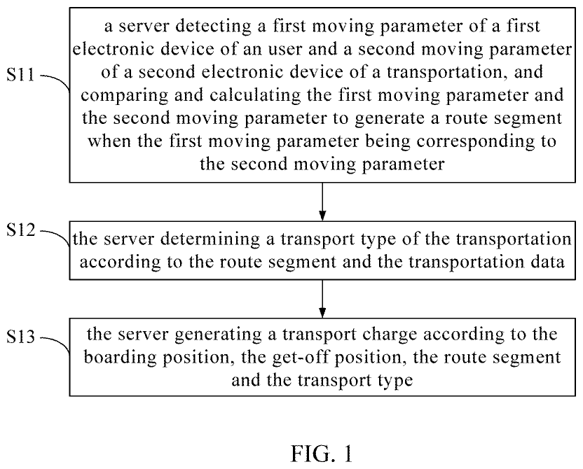

Please refer to FIG. 1. FIG. 1 is a flow chart diagram illustrating a transport charge calculating method in an embodiment of the present invention. As shown in FIG. 1, in this embodiment, the transport charge calculating method includes the following steps of: step S11: a server detecting a first moving parameter of a first electronic device of an user and a second moving parameter of a second electronic device of a transportation, and comparing and calculating the first moving parameter and the second moving parameter to generate a route segment when the first moving parameter is corresponding to the second moving parameter, wherein the first moving parameter and the second moving parameter include at least one of a moving route, a moving time, a moving speed and a moving acceleration, and the second electronic device stores a transportation data corresponding to the transportation; step S12: the server determining a transport type of the transportation according to the route segment and the transportation data; and step S13: the server generating a transport charge according to a boarding position, a get-off position, the route segment and the transport type.

In this embodiment, the first electronic device can be a smart phone, tablet, notebook, etc. and can include a positioning chip. The second electronic device can be a communicating device including the positioning chip, and the second electronic device can be disposed in the transportation or be carried by the driver. The transportation can be bus, MRT, train, high-speed rail or other public vehicles. The server can be a cloud server, a central management server, etc., and can communicate with the first electronic device and the second electronic device. In practical application, the first electronic device and the second electronic device can be installed the positioning programs or APP respectively. The server can include an electronic tracking system/platform (such as electronic map, Google map, etc.) to detect the first electronic device and the second electronic device.

In practice, the first electronic device, the second electronic device and the server can be communicated with GPS satellites. The server can locate and obtain a first position of the first electronic device and a second position of the second electronic device through GPS satellite positioning. The first position can be the user's current position, but it is not limited to, the first position can also be the start position, terminal position or the short stop position of the destination. The second position can include the current driving position or stop position of the transportation. In practice, the server can continuously detect and locate the first electronic device and the second electronic device to obtain a plurality of first positions and second positions, and can analyze and calculate the first positions and second positions to generate the first moving parameter of the first electronic device and the second moving parameter of the second electronic device respectively.

In this embodiment, the first moving parameter and the second moving parameter can include a moving speed, moving acceleration, moving route and moving time. The moving speed can be the current speed or average moving speed for moving a distance (or a period of time) of the first electronic device and the second electronic device; the moving acceleration can be the instantaneous acceleration or the average acceleration for moving a period of time of the first electronic device and the second electronic device; the moving route can be the moving direction or moving path of the first electronic device and the second electronic device; the moving time can be the time point/timestamp of the first electronic device and the second electronic device at the current locations, the time length during which the moving speeds of the first electronic device and the second electronic device are the same, the time length during which the moving accelerations of the first electronic device and the second electronic device are the same, or the stopping time length of the first electronic device and the second electronic device located at the same location. Moreover, the server can also calculate the distance between the first electronic device and the second electronic device according to the first location and the second location, but it is not limited hereto.

The server can also obtain the first position and the second position in other way. In one embodiment, the first electronic device and the second electronic device can obtain the first positions and the second positions through GPS satellite positioning respectively. Furthermore, the first electronic device and the second electronic device can also utilize Wi-Fi signals or mobile network base stations to assist in positioning, thereby improving accuracy or obtaining position information in environments without GPS signals. Then, the first electronic device and the second electronic device transmit the first positions and the second positions to the server for further processing and application.

In this embodiment, the means of the first moving parameter corresponding to the second moving parameter is that the first moving parameter of the first electronic device is equal to the second moving parameter of the second electronic device, the first moving parameter of the first electronic device is slightly equal to the second moving parameter of the second electronic device, or there is a difference between the first moving parameter of the first electronic device and the second moving parameter of the second electronic device (for example, the difference is less than 20 percent of the first moving parameter or the second moving parameter). All of the above situations can be regarded as the user riding the vehicle. In detail, when the distance between the first position and the second position is smaller than a distance threshold stored in the server and the first moving parameter is equal to the second moving parameter, the server generates the route segment according to the first moving parameter and the second moving parameter. In addition, the situation of the first moving parameter and the second moving parameter can also be the same moving time, the same moving route, and at least one of the same moving speed and moving acceleration. Then, the server calculates the segment according to the first moving parameter and the second moving parameter, wherein the route segment includes a starting position and a terminal position. In practice, the route segment is the route and distance along which the user rides in the transportation including the second electronic device. The starting position is a boarding position (that is the first position when boarding) and the terminal position is a get-off position (that is the first position when get-off).

It should be noted that the server can also obtain the first moving parameter and the second moving parameter in other way. In one embodiment, after the first electronic device and the second electronic device obtain the first positions and the second positions through GPS satellite positioning respectively, the first electronic device and the second electronic device can also calculate the first positions and the second positions to generate the first moving parameter and the second moving parameter, and then transmit the first moving parameter and the second moving parameter to the server.

In this embodiment, the second electronic device stores a transportation data corresponding to the transportation. The server generates the transport type according to the route segment and the transportation data, and then generates the transport charge according to the boarding position, the get-off position, the route segment and the transport type. In detail, the server can pre-store the driving route data and ticket price lists of a plurality of transportations. The driving route data can be bus route maps, high-speed rail route maps and MRT route maps, and can include a plurality of driving paths. The ticket price list can include a plurality of transport charges corresponding to the driving paths respectively. Moreover, the transportation data further includes an identification code, and the identification code can correspond to the transport type of the transportation. Therefore, the server can recognize the transport type of the transportation according to the identification of the second electronic device, and calculate the driving path according to the boarding position, the get-off position and the route segment, and then calculates the transport charge according to the transport type and the driving path. Therefore, the transport charge calculating method of the present invention can make the user to skip the ticket purchase step during the transportation process, thereby optimizing the riding experience and improving the convenience of taking transportation.

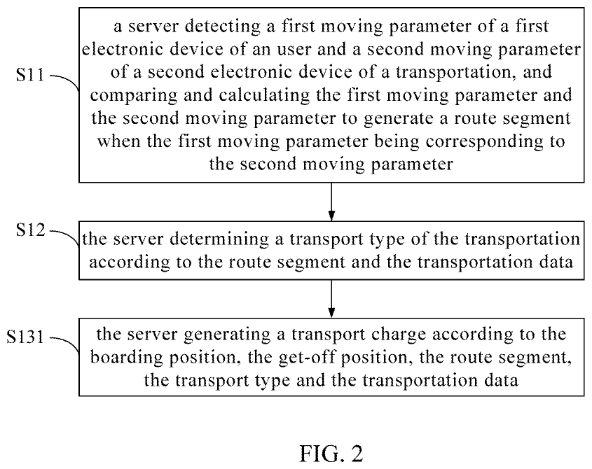

Please refer to FIG. 2. FIG. 2 is a flow chart diagram illustrating the transport charge calculating method in an embodiment of the present invention. As shown in FIG. 2, in this embodiment, the transport charge calculating method further includes the following step of: step S13: the server generating the transport charge according to the boarding position, the get-off position, the route segment, the transport type and the transportation data. In this embodiment, the transportation data can further include one of a transportation plate number, a transportation age and a device data. In practice, the device data can include driving path, driving time list, engine type, fuel/battery data, maximum passenger capacity, vehicle specifications, regular maintenance records, accident records, air conditioning/heating status, and pollution emission compliance standards. In addition, the server further stores a first comfort level table corresponding to the transportation data, and the first comfort level table has a rating from 1 to 5. The different first comfort level ratings are corresponding to different charge discounts, but it is not limited hereto. The rating method can be adjusted on a rolling basis according to the actual application situation. Therefore, the server can also adjust the transport charge according to the charge discount corresponding to the first comfort level. It should be noted that the steps of S11 and S12 in this embodiment are the same as the steps of the aforementioned embodiment, it is not described herein.

In this embodiment, the server further can generate a second comfort level according to the second moving parameter. In practice, the server can pre-store the peak period and off-peak period. The server can generate the second comfort level by determining the moving time of the second moving parameter located in the peak period and off-peak period. Then, the server can adjust the transport charge according to the second comfort level and the aforementioned first comfort level. The second comfort level table has a rating from 1 to 5, and the different second comfort level ratings are corresponding to different charge discounts, but it is not limited hereto. The rating method can be adjusted on a rolling basis according to the actual application situation. Therefore, the transport charge calculating method of the present invention can eliminate the unfair complaints from passengers due to differences in riding experience caused by vehicle congestion, thereby improving the satisfaction of public transportation services.

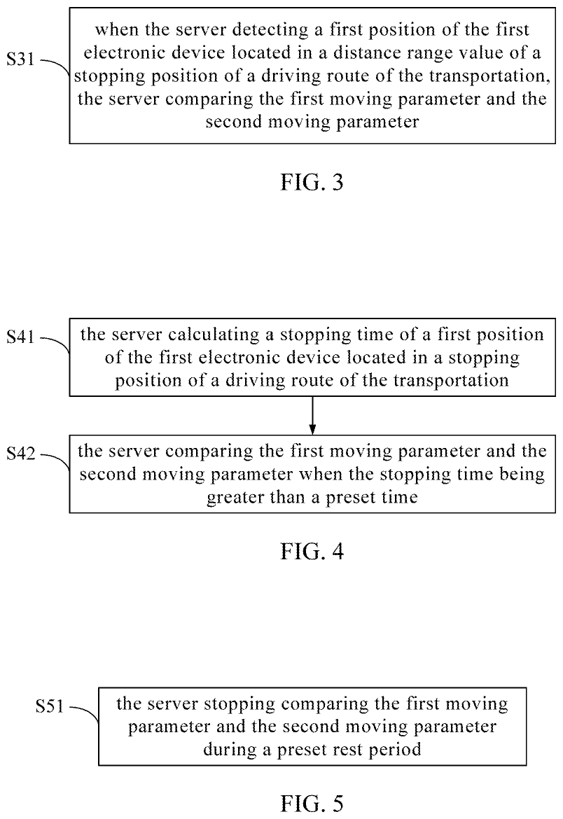

Please refer to FIG. 3. FIG. 3 is a flow chart diagram illustrating the transport charge calculating method in an embodiment of the present invention. As shown in FIG. 3, in this embodiment, the transport charge calculating method further includes the following step of: step S31: when the server detecting a first position of the first electronic device located in a distance range value of a stopping position of a driving route of the transportation, the server comparing the first moving parameter and the second moving parameter. In practice, the server can pre-store the distance range value and driving route data of a plurality of transportations, and the driving route data can include the stopping positions of the driving route, that is to say, the stopping positions of the driving route can be the stops or stop locations of the transportations. Moreover, the detecting range of the distance range value can be 10 m, but it is not limited hereto. When the first position of the first electronic device is located in the distance range value of the stop of the transportation, the server compares the first moving parameter of the first electronic device and the second moving parameter of the second electronic device. When the first electronic device is located out of the distance range value, the server will stop comparing the first moving parameter and the second moving parameter. Therefore, when the user passes by the stop and located in the distance range value, the server will compare the first electronic device and the plurality of second electronic devices passing by the stop until the user moves out of the distance range value.

Please refer to FIG. 4. FIG. 4 is a flow chart diagram illustrating the transport charge calculating method in an embodiment of the present invention. As shown in FIG. 4, in this embodiment, the transport charge calculating method further includes the following steps of: step S41: the server calculating a stopping time of a first position of the first electronic device located in a stopping position of a driving route of the transportation; and step S42: the server comparing the first moving parameter and the second moving parameter when the stopping time being greater than a preset time. In practice, the server can pre-store the driving route data, the stop location data and the preset time. When the server detects that the first position of the first electronic device is located at the stop location (that is stop position) or near the stop location (such as the distance between the first position and the stop location is less than 5 m), the server calculate the stopping time of the first electronic device located at the stop location. Furthermore, when the first electronic device is located at the stop location, it means that the user intends to take the transportation. At this time, the server starts to detect and calculate the first position, the second position, the first moving parameter and the second moving parameter. In practice, the preset time can be 5 minutes, but it is not limited hereto. The preset time can be adjusted on a rolling basis according to the actual application situation. In practical application, the server can detect the first position of the first electronic device is located at the bus stop or platform of the high-speed rail at first. When the stopping time of the first electronic device is greater than a preset time, the server determines that the user intends to take the bus or high-speed rail, and then starts to detect and compare the first position and the first moving parameter of the first electronic device and the second position and the second moving parameter of the second electronic device, to reduces the idle time of related units within the server, thereby reducing energy consumption and operating costs.

In addition, the server also can determine the distance between the stop location and the second electronic device, and determine the time of the transportation arrived at the stop location according to the distance and the second moving parameter. Therefore, the transport charge calculating method also can estimate the arrival time of the transportation, thereby increasing the accuracy.

Please refer to FIG. 5. FIG. 5 is a flow chart diagram illustrating the transport charge calculating method in an embodiment of the present invention. As shown in FIG. 5, in this embodiment, the transport charge calculating method further includes the following step of: step S51: the server stopping comparing the first moving parameter and the second moving parameter during a preset rest period. In practice, the server can pre-store the preset rest period, and the server stops comparing the first position, the second position, the first moving parameter and the second moving parameter during a preset rest period. Wherein, the preset rest period can be a time when the user will not take the transportation or the transportation is not operating, but it is not limited hereto. The preset rest period also can be determined by the first electronic device, and the first electronic device can send the preset rest period to the server. In practice, the preset rest period can be from 00:30 a.m. to 04:00 a.m., and the server will stop detecting and executing the charge calculating functions. Therefore, the transport charge calculating method of the present invention can achieve intermittent operation, thereby effectively reducing energy consumption.

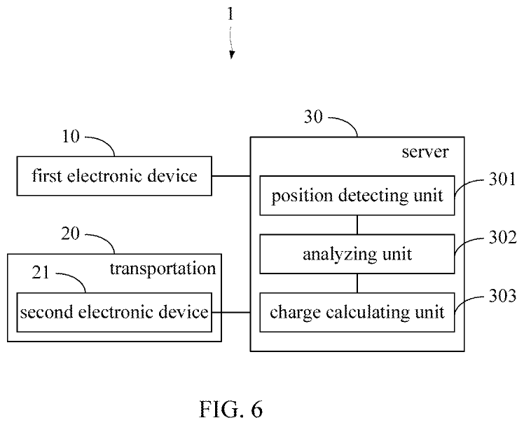

Please refer to FIG. 6. FIG. 6 is a functional block diagram illustrating a transport charge calculating system 1 in an embodiment of the present invention. The steps from FIG. 1 to FIG. 5 can be executed by transport charge calculating system 1 of FIG. 6. As shown in FIG. 6, the transport charge calculating system 1 includes a first electronic device 10, a transportation 20 and a server 30. The transportation 20 includes a second electronic device 21. The second electronic device 21 stores a transportation data corresponding to the transportation 20. The server 30 is communicated with the first electronic device 10 and the second electronic device 21, and the server 30 further includes a position detecting unit 301, an analyzing unit 302 and a charge calculating unit 303. The position detecting unit 301 is configured to detect a first moving parameter of the first electronic device 10 and a second moving parameter of the second electronic device 21. The analyzing unit 302 is connected to the position detecting unit 301 and configured to compare and calculate the first moving parameter and the second moving parameter. The analyzing unit 302 generates a route segment according to the first moving parameter and the second moving parameter when the first moving parameter is corresponding to the second moving parameter. The charge calculating unit 303 is connected to the analyzing unit 302. The charge calculating unit 303 is configured to determine a transport type of the transportation 20 according to the route segment and the transportation data, and generate a transport charge according to the boarding position, the get-off position, the route segment and the transport type.

In this embodiment, the analyzing unit 302 further pre-stores the distance range value and driving route data of a plurality of transportations, and the driving route data can include the stopping positions of the driving route, that is to say, the stopping positions of the driving route can be the stops or stop locations of the transportations. In this embodiment, when the first electronic device 10 is located in the distance range value of the stop of the transportation, the analyzing unit 302 compares the first moving parameter of the first electronic device 10 and the second moving parameter of the second electronic device 21. Moreover, the detecting range of the distance range value can be 10 m, but it is not limited hereto.

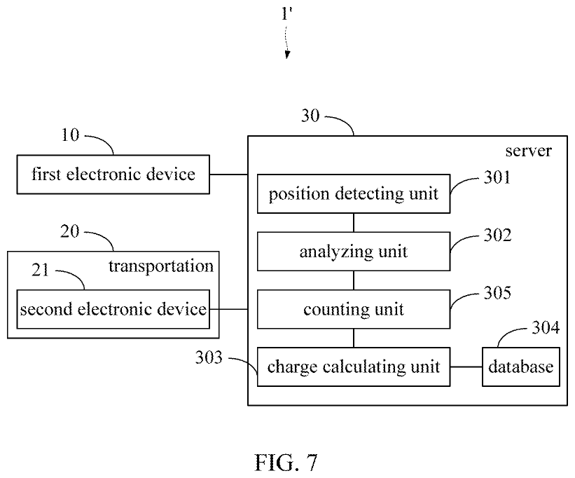

Please refer to FIG. 7. FIG. 7 is a functional block diagram illustrating the transport charge calculating system 1′ in an embodiment of the present invention. As shown in FIG. 7, the difference between this embodiment and aforementioned embodiment is that the server 30 further includes a database 304 and a counting unit 305. The database 304 is connected to the charge calculating unit 303 and configured to store the driving route data and ticket price lists of a plurality of transportations. The analyzing unit 302 is connected to the database 304 and configured to compare the first position and the driving route data to generate the first stopping signal. That is to say, when the current position of the user is located at the bus stop or platform of the high-speed rail or the distance between the current position and the stop/platform is less than 5 m, the analyzing unit 302 generates the first stopping signal. Furthermore, the counting unit 305 is connected to the analyzing unit 302 and pre-store a preset time. The counting unit 305 is configured to receive the first stopping signal to calculate a stopping time of the first electronic device 10, and to generate a first comparing signal when the stopping time is greater than or equal to the preset time. The analyzing unit 302 can receive the first comparing signal and compare the first position, the second position, the first moving parameter and the second moving parameter according to the first comparing signal. In detail, when the first electronic device 10 is located at the stop location over the preset time, it means that the user intends to take the transportation, and the counting unit 305 generates the first comparing signal. In practice, the preset time can be 5 minutes, but it is not limited hereto. The preset time can be adjusted on a rolling basis according to the actual application situation.

In this embodiment, the transportation data includes one of the transportation plate number, the transportation age, the device data and the identification code. The charge calculating unit 303 generates the transport charge according to the boarding position, the get-off position, the route segment, the transport type and the transportation data. In addition, the charge calculating unit 303 can also adjust the transport charge according to the aforementioned first comfort level and second comfort level.

In this embodiment, the analyzing unit 302 further pre-stores the preset rest period, but it is not limited thereto. The preset rest period also can be stored in the database 304 or inputted by the first electronic device 10. The analyzing unit 302 does not comparing the first position, the second position, the first moving parameter and the second moving parameter during the preset rest period. That is, the transport charge calculating system 1′ of the present invention is temporarily unavailable during the preset rest period.

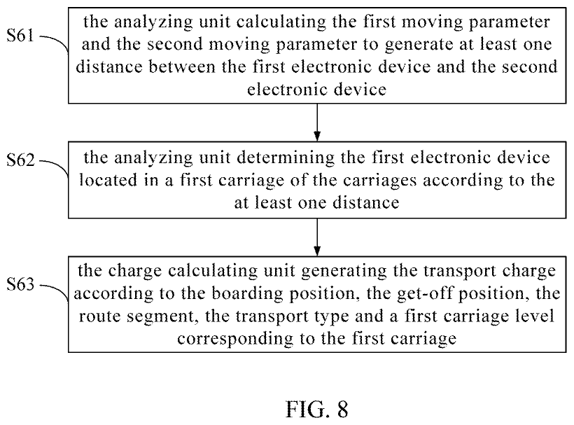

Please refer to FIG. 8. FIG. 8 is a flow chart diagram illustrating the transport charge calculating method in an embodiment of the present invention. The steps of FIG. 8 can be executed by transport charge calculating system 1′ of FIG. 7. As shown in FIG. 8, in this embodiment, the transport charge calculating method further includes the following steps of: step S61: the analyzing unit 302 calculating the first moving parameter and the second moving parameter to generate at least one distance between the first electronic device 10 and the second electronic device 21; step S62: the analyzing unit 302 determining the first electronic device located in a first carriage of the carriages according to the at least one distance; and step S63: the charge calculating unit 303 generating the transport charge according to the boarding position, the get-off position, the route segment, the transport type and a first carriage level corresponding to the first carriage.

In step S61, the transportation 20 further includes a plurality of carriages, and the carriages are corresponding to a carriage level respectively. In practice, the transportation 20 can be MRT, train, high-speed rail or other public transportation with different carriage/seat levels. Furthermore, the carriage level can include first class, business class, reserved seat, unreserved seat, etc. After the user boarding on the transportation 20, the position detecting unit 301 still can locate the first position of the first electronic device 10 and the second position of the second electronic device 21.

In step S62, the analyzing unit 302 can receive the first position and the second position and calculate the distance between the first electronic device 10 and the second electronic device 21, to determine the user's location within the carriage of transportation 20. For example, the carriage length of each of carriages is 24 m and the second electronic device 21 is disposed in the first carriage. When the analyzing unit 302 calculates the distance between the first electronic device 10 and the second electronic device 21 is 80 m, then the analyzing unit 302 can determine that the user is located in the fourth carriage.

In step S63, the database 304 also can store a plurality of carriage charge corresponding to the carriage levels and carriage number respectively. Therefore, the charge calculating unit 303 can generate the transport charge according to the riding route, the transport type and carriage level at the same time.

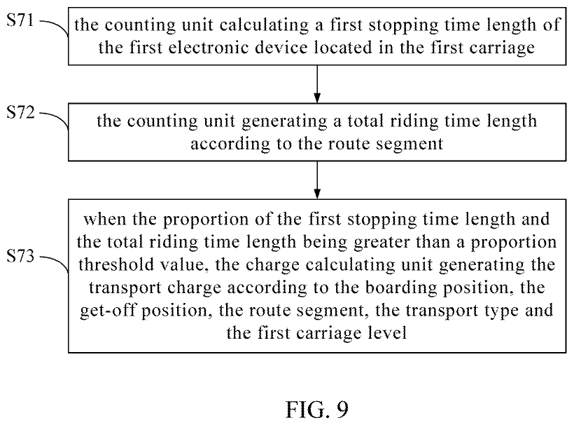

Please refer to FIG. 9. FIG. 9 is a flow chart diagram illustrating the transport charge calculating method in an embodiment of the present invention. The steps of FIG. 9 can be executed by transport charge calculating system 1′ of FIG. 7. As shown in FIG. 9, in this embodiment, the transport charge calculating method further includes the following steps of: step S71: the counting unit 305 calculating a first stopping time length of the first electronic device 10 located in the first carriage; step S72: the counting unit 305 generating a total riding time length according to the route segment; and step S73: when the proportion of the first stopping time length and the total riding time length being greater than a proportion threshold value, the charge calculating unit 303 generating the transport charge according to the boarding position, the get-off position, the route segment, the transport type and the first carriage level.

In step S71, when the analyzing unit 302 determines that the user is located in the carriage of the transportation 20, the counting unit 305 calculates the first stopping time length of the first electronic device 10 located in the carriage. In practice, the analyzing unit 302 can pre-store a time length threshold. When the counting unit 305 detects that the first stopping time length is greater than the time length threshold, it means that the user is located at the carriage. In one embodiment, the analyzing unit 302 also can determine that the user is located in the carriage of the transportation 20 according to the distance and the stopping time length. In practice, when the distance between the first electronic device 10 and the second electronic device 21 remains constant and the first stopping time length is greater than the time length threshold, it means that the user is located at the carriage. When the distance between the first electronic device 10 and the second electronic device 21 continuously changes, it means that the user passes by the carriage.

In step S72, the route segment includes the starting position and the terminal position. The starting position includes the boarding time points/timestamp and the terminal position includes the get-off time points/timestamp. The counting unit 305 can calculate and generate the total riding time length according to the boarding time points/timestamp and the get-off time points/timestamp, that is the total riding time length of the route segment. Furthermore, the analyzing unit 302 can calculate the proportion of the first stopping time length and the total riding time length.

In step S73, the charge calculating unit 303 can pre-store the proportion threshold value. In practice, the proportion threshold value can be adjusted on a rolling basis according to the actual application situation. When the proportion of the first stopping time length and the total riding time length is greater than the proportion threshold value, it means that the user is locate at the carriage in the route segment, then the charge calculating unit 303 generates the transport charge according to the route segment and the carriage level.

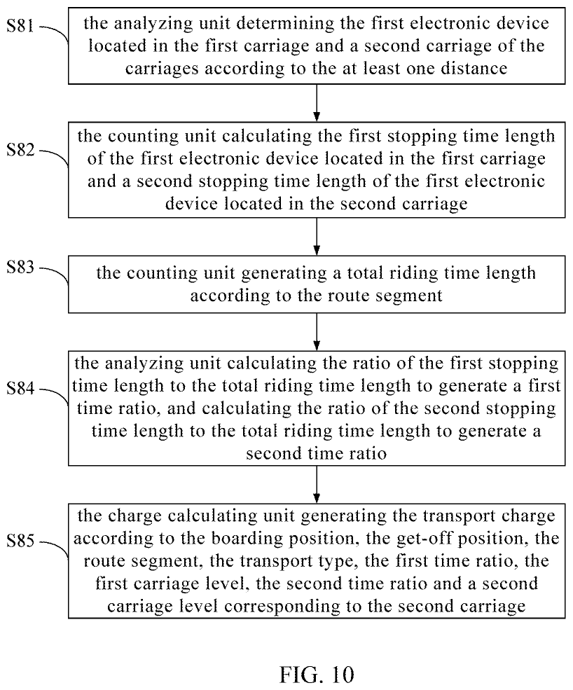

The transport charge calculating method and system of the present invention also can determine the user's location within a plurality of carriages. Please refer to FIG. 10. FIG. 10 is a flow chart diagram illustrating the transport charge calculating method in an embodiment of the present invention. The steps of FIG. 10 can be executed by transport charge calculating system 1′ of FIG. 7. As shown in FIG. 10, in this embodiment, the transport charge calculating method further includes the following steps of: step S81: the analyzing unit 302 determining the first electronic device located in the first carriage and a second carriage of the carriages according to the at least one distance; step S82: the counting unit 305 calculating the first stopping time length of the first electronic device located in the first carriage and a second stopping time length of the first electronic device located in the second carriage; step S83: the counting unit 305 generating a total riding time length according to the route segment; step S84: the analyzing unit 302 calculating the ratio of the first stopping time length to the total riding time length to generate a first time ratio, and calculating the ratio of the second stopping time length to the total riding time length to generate a second time ratio; and step S85: the charge calculating unit 303 generating the transport charge according to the boarding position, the get-off position, the route segment, the transport type, the first time ratio, the first carriage level, the second time ratio and a second carriage level corresponding to the second carriage.

In step S81, the user may change seat or carriage during the route segment in practice. At this time, the position detecting unit 301 can locate the plurality of positions (such as the first position and the second position) of the first electronic device 10 in the transportation 20. Then, the analyzing unit 302 can calculate the first distance between the first position and the second electronic device 21 and the second distance between the second position and the second electronic device 21, and determine the first carriage and the second carriage according to the first distance and the second distance respectively.

In steps S82 and S83, the counting unit 305 can count and record the first stopping time length and the second stopping time length of first electronic device 10 in the first carriage and the second carriage respectively, to determine the riding time of the user in different carriages. Furthermore, the counting unit 305 can calculate and generate the total riding time length according to the boarding time points/timestamp and the get-off time points/timestamp.

In step S84, the analyzing unit 302 can calculate the first time ratio of the proportion of the first stopping time length and the total riding time length, and calculate the second time ratio of the proportion of the second stopping time length and the total riding time length.

In step S85, the first carriage includes a first carriage level and the second carriage includes a second carriage level. The first carriage level and the second carriage level can be corresponding to the same or different charges. Therefore, the charge calculating unit 303 can further adjust the transport charge according to the first time ratio, the first carriage level, the second time ratio and the second carriage level, thereby increasing the fairness.

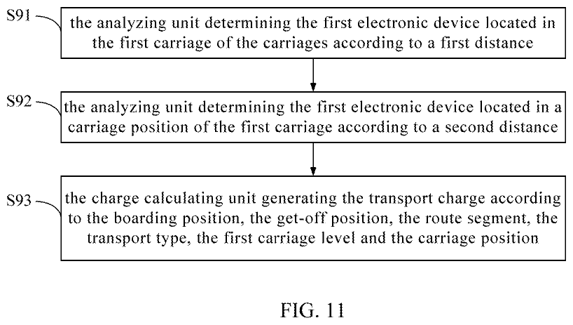

The transport charge calculating method and system of the present invention also can determine different locations of the user in one carriage. Please refer to FIG. 11. FIG. 11 is a flow chart diagram illustrating the transport charge calculating method in an embodiment of the present invention. The steps of FIG. 11 can be executed by transport charge calculating system 1′ of FIG. 7. As shown in FIG. 11, in this embodiment, the transport charge calculating method further includes the following steps of: step S91: the analyzing unit 302 determining the first electronic device located in the first carriage of the carriages according to a first distance; step S92: the analyzing unit 302 determining the first electronic device located in a carriage position of the first carriage according to a second distance; and step S93: the charge calculating unit 303 generating the transport charge according to the boarding position, the get-off position, the route segment, the transport type, the first carriage level and the carriage position.

In step S91: the position detecting unit 301 can locate the first position of the first electronic device 10 in the transportation 20. The analyzing unit 302 can calculate the first distance between the first position and the second electronic device 21, and determine the first carriage of the user according to the first distance.

In step S92, the carriage position can include a standing area and a seat area. In practice, the standing area can be the aisles of the transportation 20, the seat area can be the seats of the transportation 20, and the standing area and the seat area can include the distance ranges respectively. The position detecting unit 301 further can locate the second position of the first electronic device 10 in first carriage, and the analyzing unit 302 can determine carriage position of the user according to the second position, the second electronic device 21 and the distance ranges.

In step S93, the standing area and the seat area can be corresponding to the different charges. Therefore, the charge calculating unit 303 can further adjust the transport charge according to carriage position, thereby increasing the fairness.

In summary, the transport charge calculating method and system of the present invention can determine whether the user is taking on transportations and automatically calculate the transport charge according to the route segment, to solve various travel problems caused by the need to buy tickets in advance when taking public transportation, thereby improving the convenience of taking public transportation.

Furthermore, the transport charge calculating method and system of the present invention also can determine whether the user intends to take the transportation according to the stopping time, and can stop comparing the first moving parameter and the second moving parameter during a preset rest period, to identify the appropriate time to start the relevant units and avoid unnecessary idling, thereby reducing energy consumption and improving system efficiency.

Moreover, the transport charge calculating method and system of the present invention also can adjust the transport charge according to the transportation data, the comfort level, carriage level, different carriages and carriage positions during the riding route, thereby improving the fairness of ticket prices and passenger satisfaction.

In addition, the transport charge calculating method and system of the present invention also can estimate the arrival time of the transportation, thereby increasing the accuracy.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A transport charge calculating method, comprising the following steps of:
a server detecting a first moving parameter of a first electronic device of an user and a second moving parameter of a second electronic device of a transportation, and comparing and calculating the first moving parameter and the second moving parameter to generate a route segment when the first moving parameter being corresponding to the second moving parameter, wherein the first moving parameter and the second moving parameter comprise at least one of a moving route, a moving time, a moving speed and a moving acceleration, and the second electronic device stores a transportation data corresponding to the transportation, the route segment comprises a starting position and a terminal position, the starting position is a boarding position and the terminal position is a get-off position;
the server determining a transport type of the transportation according to the route segment and the transportation data; and
the server generating a transport charge according to the boarding position, the get-off position, the route segment and the transport type.

2. The transport charge calculating method of claim 1, wherein the transportation data comprises one of a transportation plate number, a transportation age, a device data and an identification code, and the step of the server generating the transport charge according to the boarding position, the get-off position, the route segment and the transport type further comprises the following step of:
the server generating the transport charge according to the boarding position, the get-off position, the route segment, the transport type and the transportation data.

3. The transport charge calculating method of claim 1, further comprising the following step of:
when the server detecting a first position of the first electronic device located in a distance range value of a stopping position of a driving route of the transportation, the server comparing the first moving parameter and the second moving parameter.

4. The transport charge calculating method of claim 1, further comprising the following steps of:
the server calculating a stopping time of a first position of the first electronic device located in a stopping position of a driving route of the transportation; and
the server comparing the first moving parameter and the second moving parameter when the stopping time being greater than a preset time.

5. The transport charge calculating method of claim 1, further comprising the following step of:
the server stopping comparing the first moving parameter and the second moving parameter during a preset rest period.

6. The transport charge calculating method of claim 1, wherein the transportation comprises a plurality of carriages, and the carriages are corresponding to a carriage level respectively, the transport charge calculating method further comprises the following steps of:
the server calculates the first moving parameter and the second moving parameter to generate at least one distance between the first electronic device and the second electronic device;
the server determines the first electronic device located in a first carriage of the carriages according to the at least one distance;
and, the step of the server generating the transport charge according to the boarding position, the get-off position, the route segment and the transport type further comprises the following step of:
the server generating the transport charge according to the boarding position, the get-off position, the route segment, the transport type and a first carriage level corresponding to the first carriage.

7. The transport charge calculating method of claim 6, further comprising the following steps of:
the server calculating a first stopping time length of the first electronic device located in the first carriage;
the server generating a total riding time length according to the route segment;
and, the step of the server generating the transport charge according to the boarding position, the get-off position, the route segment, the transport type and a first carriage level corresponding to the first carriage further comprising the following step of:
when the proportion of the first stopping time length and the total riding time length being greater than a proportion threshold value, the server generating the transport charge according to the boarding position, the get-off position, the route segment, the transport type and the first carriage level.

8. The transport charge calculating method of claim 6, wherein the step of the server determining the first electronic device located in the first carriage of the carriages according to the at least one distance further comprises the following steps of:
the server determines the first electronic device located in the first carriage and a second carriage of the carriages according to the at least one distance;
the server calculates a first stopping time length of the first electronic device located in the first carriage and a second stopping time length of the first electronic device located in the second carriage;
and, the step of the server generating the transport charge according to the boarding position, the get-off position, the route segment, the transport type and a first carriage level corresponding to the first carriage further comprising the following steps of:
the server generates a total riding time length according to the route segment;
the server calculates the ratio of the first stopping time length to the total riding time length to generate a first time ratio, and calculates the ratio of the second stopping time length to the total riding time length to generate a second time ratio; and
the server generates the transport charge according to the boarding position, the get-off position, the route segment, the transport type, the first time ratio, the first carriage level, the second time ratio and a second carriage level corresponding to the second carriage.

9. The transport charge calculating method of claim 6, wherein the step of the server determining the first electronic device located in the first carriage of the carriages according to the at least one distance further comprises the following steps of:
the server determines the first electronic device located in the first carriage of the carriages according to a first distance;
the server determines the first electronic device located in a carriage position of the first carriage according to a second distance, wherein the carriage position comprises a standing area and a seat area;
and, the step of the server generating the transport charge according to the boarding position, the get-off position, the route segment, the transport type and a first carriage level corresponding to the first carriage further comprising the following step of:
the server generates the transport charge according to the boarding position, the get-off position, the route segment, the transport type, the first carriage level and the carriage position.

10. A transport charge calculating system, comprising:
a first electronic device;
a transportation, comprising a second electronic device, the second electronic device storing a transportation data corresponding to the transportation; and
a server, communicated with the first electronic device and the second electronic device, the server further comprising:
a position detecting unit, configured to detect a first moving parameter of the first electronic device and a second moving parameter of the second electronic device, wherein the first moving parameter and the second moving parameter comprise at least one of a moving route, a moving time, a moving speed and a moving acceleration;
an analyzing unit, configured to compare and calculate the first moving parameter and the second moving parameter, the analyzing unit generating a route segment according to the first moving parameter and the second moving parameter when the first moving parameter being corresponding to the second moving parameter, wherein the route segment comprises a starting position and a terminal position, the starting position is a boarding position and the terminal position is a get-off position; and
a charge calculating unit, configured to determine a transport type of the transportation according to the route segment and the transportation data, and generate a transport charge according to the boarding position, the get-off position, the route segment and the transport type.

11. The transport charge calculating system of claim 10, wherein the transportation data comprises one of a transportation plate number, a transportation age, a device data and an identification code, and the charge calculating unit generates the transport charge according to the boarding position, the get-off position, the route segment, the transport type and the transportation data.

12. The transport charge calculating system of claim 10, wherein when the position detecting unit determines a first position of the first electronic device located in a distance range value of a stopping position of a driving route of the transportation, the analyzing unit compares the first moving parameter and the second moving parameter.

13. The transport charge calculating system of claim 10, wherein the server further comprises a counting unit, the counting unit is connected to the analyzing unit and stores a preset time, the counting unit is configured to calculate a stopping time of a first position of the first electronic device located in a stopping position of a driving route of the transportation, and the analyzing unit compares the first moving parameter and the second moving parameter when the stopping time is greater than a preset time.

14. The transport charge calculating system of claim 10, wherein the analyzing unit stops comparing the first moving parameter and the second moving parameter during a preset rest period.

15. The transport charge calculating system of claim 13, wherein the transportation comprises a plurality of carriages, and the carriages are corresponding to a carriage level respectively, the analyzing unit calculates the first moving parameter and the second moving parameter to generate at least one distance between the first electronic device and the second electronic device, and determines the first electronic located in a first carriage of the carriages according to the at least one distance, the charge calculating unit generates the transport charge according to the boarding position, the get-off position, the route segment, the transport type and a first carriage level corresponding to the first carriage.

16. The transport charge calculating system of claim 15, wherein the counting unit calculates a first stopping time length of the first electronic device located in the first carriage, and generates a total riding time length according to the route segment, when the proportion of the first stopping time length and the total riding time length is greater than a proportion threshold value, the charge calculating unit generates the transport charge according to the boarding position, the get-off position, the route segment, the transport type and the first carriage level.
